(19) United States
(12) Patent Application Publication
(10) Pub. No.: US 2014/0034677 A1
(43) Pub. Date: Feb. 6, 2014

(54) CLOSED-SYSTEM FLUID MEASURING AND DISPENSING DEVICE, SYSTEM AND METHOD

(71) Applicant: Gregg PAGLIARULO, Dania Beach, FL (US)

(72) Inventor: Gregg PAGLIARULO, Dania Beach, FL (US)

(21) Appl. No.: 13/957,058

(22) Filed: Aug. 1, 2013

Related U.S. Application Data
(60) Provisional application No. 61/679,344, filed on Aug. 3, 2012.

(51) Int. Cl. B67D 7/56; B65D 37/00; B67D 7/06

(52) U.S. Cl. CPC B05B 11/0089
USPC 222/158; 222/205; 222/207; 222/211

(57) ABSTRACT

A closed-system fluid measuring and dispensing device is mounted to a container that draws a fluid from the container into the device and dispenses a measured amount of fluid from the device. More particularly, a closed-volume fluid reservoir in mated to the threaded neck of a bottle. Fluid flows through a tube of the device from the bottle into the reservoir. The device is inverted to dispense a desired amount of liquid from the reservoir.

### CROSS-REFERENCE TO RELATED APPLICATIONS

The present application claims priority to: co-pending Provisional Patent Application No. 61/679,344, filed on Aug. 3, 2012, entitled “CLOSED FLUID MEASURING AND DISPENSING DEVICE”; that application being incorporated herein, by reference, in its entirety.

### BACKGROUND OF THE INVENTION

1. Field of the Invention

The present invention relates to a closed-system fluid measuring and dispensing device, system and method, and, more particularly, to a closed-system device that can be mounted to a container to draw a fluid from the container into the device and to dispense a measured amount of fluid from the device.

2. Description of the Related Art

Conventional methods for measuring and dispensing commercially available liquids, oils, and concentrated agriculture products from their containers often entails utilizing some form of open measuring device, such as a measuring cup or common kitchen tablespoon, which are usually never around when needed. In many cases, individuals resort to direct pouring of the product straight from the container using best guess estimation measurement practices, often causing inaccurate product mixing, product waste, and personal contamination risk.

Some commercially available product lines have recognized this problem and now offer an open measuring system with the product, such as an attached measuring cup. Some products have included a closed measuring system which is built directly into the product container. Additionally, some have produced products that must be used in conjunction with their specifically attached squeezable fluid container.

See, for example, U.S. Pat. Nos. 2,311,367, 3,179,301, 3,628,700, 3,752,366, 4,106,673, 5,601,212, 5,967,377 and 7,222,755.

What is needed is a measuring device that offers all of the benefits of a closed measuring system, that delivers variable accurate measurements, is reusable and is compatible with multiple types and sizes of container.

### SUMMARY OF THE INVENTION

The present invention provides a reusable, closed-system measuring and dispensing device for use on threaded commercial product containers and a system and method for using such a device. In one particular embodiment of the invention, a measuring and dispensing device includes a lower base adapter for use on threaded commercial product containers. Above a base plate of the lower base adapter, a flexible, upper closed-system fluid reservoir is provided. If desired, the outer surface of the fluid reservoir can include measurement markings.

Other features, which are considered as characteristic for the invention, are set forth in the drawings and the appended claims.

Although the invention is illustrated and described herein as embodied in a portable closed fluid measuring and dispensing device, system and method, it is nevertheless not intended to be limited to the details shown, since various modifications and structural changes may be made therein without departing from the spirit of the invention and within the scope and range of equivalents of the claims.

The construction of the invention, together with additional objects and advantages thereof, will be best understood from the following description of the specific embodiment when read in connection with the accompanying drawings.

### BRIEF DESCRIPTION OF THE SEVERAL VIEWS OF THE DRAWINGS

For a fuller understanding of the nature of the present invention reference should be made to the following detailed description taken in connection with the accompanying drawings in which:

FIG. 1A is an exploded view of a closed-system measuring device in accordance with one particular embodiment of the present invention.

FIG. 1B is a side plan view of the closed-system measuring device of FIG. 1A.

FIG. 2A is an exploded view of a closed-system measuring device including a thread adapter, in accordance with another particular embodiment of the present invention.

FIG. 2B is a side plan view of the closed-system measuring device of FIG. 2A.

FIGS. 3 and 4 are side views of a closed-system measuring device in accordance with one particular embodiment of the invention, which are useful in explaining a method of use.

FIG. 5 is a side view of a closed-system measuring device filled in accordance with another embodiment of the invention.

### DETAILED DESCRIPTION OF THE PREFERRED EMBODIMENT

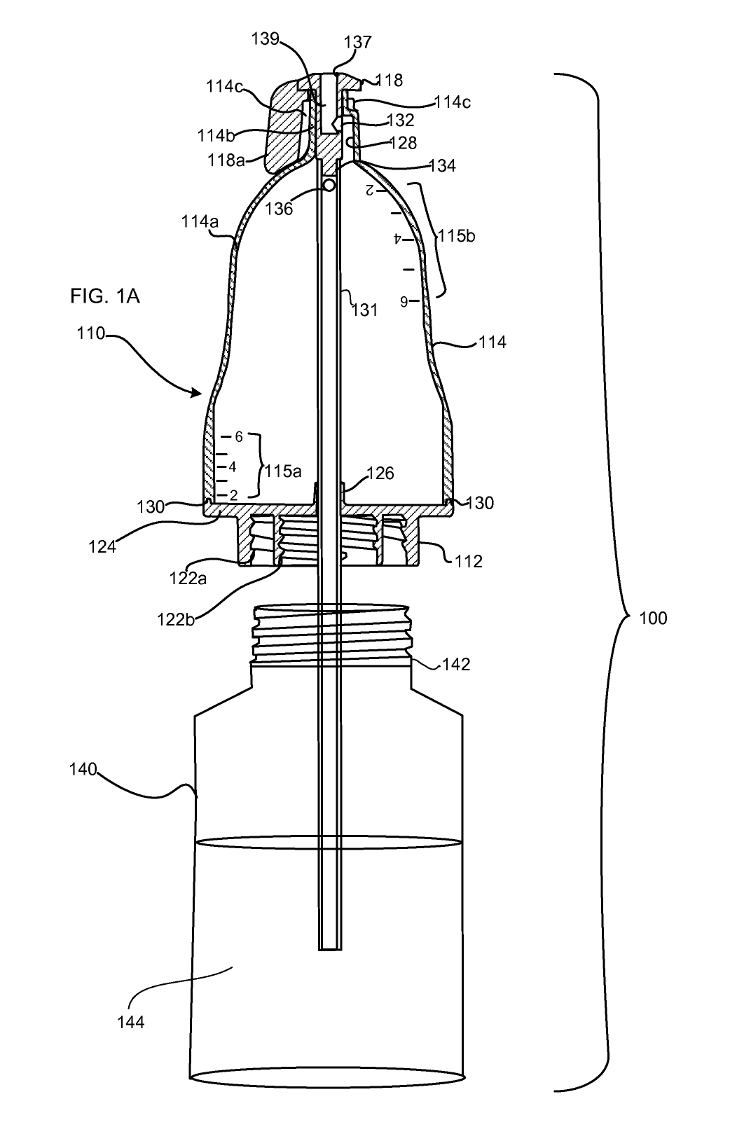

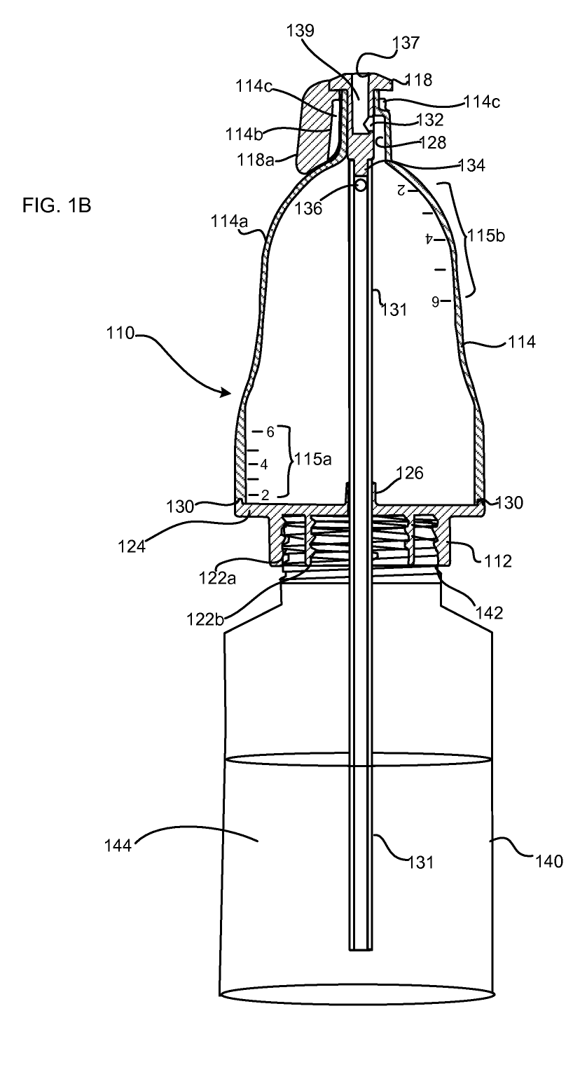

Referring now to FIGS. 1A-1B, there is shown an exploded view of a pouring system 100 including a closed-system (i.e., closed volume) measuring and dispensing device 110 in accordance with one particular embodiment of the present invention, which mates with the threaded neck 142 of a bottle 140. More particularly, the device 110 includes a base adapter portion 112, a closed fluid reservoir portion 114, a hollow tube 131, and an on/off tip valve 118. The base adapter portion 112 includes at least one set of threads 122a, for mating engagement with a thread 142 on the container 140.

In one particular embodiment of the invention, the base adapter portion 112 of the device 110 includes a plurality of differently sized integrated cut threads 122a and 122b for mounting the device 110 on a variety of containers having differently sized threaded necks 142. For example, in the embodiment illustrated, base adapter portion 112 includes two different threaded connector portions 122a, 122b, so that the device 110 can mate with bottles having a threaded neck 142 sized to mate with either the connector portion 122a or the connector portion 122b. The two connector portions 122a, 122b are arranged concentrically around a hole 126 through the base portion floor or membrane 124. The two connector portions 122a, 122b are sized to permit mating with one or the other of the connector portions without obstruction. For example, when a threaded neck is mated with the outer connector portion 122a, the inner connector portion 122b is sized to be slidably received within the mouth of the bottle 140. When a threaded neck 142 is mated with the inner connector portion 122b, the outer connector portion 122a is not engaged with the bottle 140. If desired, more than two connector portions may be provided as part of the base adapter portion 112.

The base adapter portion 112 including multiple thread connector portions is fixed to, and most preferably, formed as part of the base portion floor or solid membrane 124. Base portion floor 124 may be flexible or may be rigid, as desired. It includes a centered hole 126 therethrough, for engaging and passing through a hollow tube 131. One end of the hollow tube 131 is mated with the lower end of an on/off dispensing tip 118, while the other end is disposed in commercial liquid container or bottle 140, preferably, close to the bottom of the bottle 140. The on/off dispensing tip 118 includes two dispensing ports or orifices 132 and 137 disposed at right angles to one another and connected by a chamber 139, allowing fluid flow there between. The hollow tube 131 additionally includes opposing holes 136 at the upper end, in both directions, where the upper end of the tube 131 mates with the bottommost portion of the on/off valve tip 118. Note that, in the present preferred embodiment, the hollow tube 131 is physically connected to said on/off dispensing valve tip 118, but is not in fluid communication with the chamber 139 or ports 132 and 137, thereof.

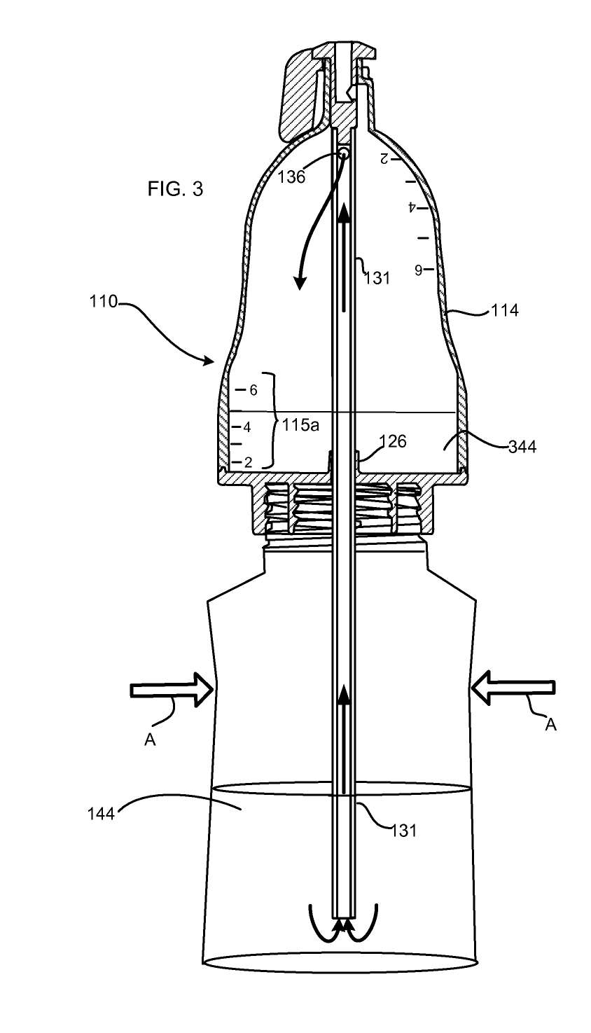

The holes 136 of the hollow tube 131 are in fluid communication with the internal volume of the upper reservoir portion 114. As will be described more particularly in connection with FIG. 3, a flow of liquid from the chamber 144 of the bottle 140 is passed into the lower end of the hollow tube 131, up through the base portion floor 124, out the holes 136, and into the fluid chamber defined by the upper reservoir portion 114. The walls of the upper fluid reservoir portion 114 are, preferably, flexible, and define a set fluid volume. Optionally, fluid measurement markings 115a and/or 115b are included on the outer wall 114a of the upper fluid reservoir portion 114.

In one particularly preferred embodiment illustrated, the upper reservoir portion 114 is bell-shaped or bullet-shaped, having a wide lower belt portion, a curved body and shoulder portion 114a and a tapered neck or fluid tip end 114b. Note that the sidewall 114a of the reservoir portion could be formed in some other type of tapered shape, if desired, including, but not limited to, frustoconical, conical, etc., without departing from the scope of the invention. The fluid tip end 114b is sized to receive the body of the on/off tip valve 118 therein. Additionally, if desired, an interlocking groove and ring arrangement (not shown) can be included on the upper portion of the body of valve 118 and the inner surface of the fluid tip end 114b, so that, once inserted into the tip end 114b, the interlocking arrangement provides resistance preventing the body of the on/off tip valve 118 from unintentionally migrating out of the tip end 114b.

An upper flange surrounds an orifice 137 of the on/off tip valve 118 and delimits the portion of the body of the on/off tip valve 118 that can be received in the fluid tip end 114b. A tab 118a extends from one side of the upper flange, for use in rotating the on/off tip valve 118, clockwise or counter-clockwise within the fluid tip end 114b, in order to move the orifice 132 in the body of the on/off tip valve 118 between an enlarged fluid-flow channel 128 formed in the fluid tip end 114a, and a wall of the fluid tip end 114b. More particularly, in a first position of the on/off tip valve 118, the channel 128 formed in the fluid tip end 114b provides a fluid path from the main body of the upper fluid reservoir 114 and an orifice 132 formed in the on/off tip valve 118. The orifice 132 is in fluid communication with a chamber 139 in the on/off tip valve 118, at the other end of which is the outlet orifice 137. Fluid entering the orifice 132, via the channel 128, can thus be poured out through the orifice 137.

In a second position of the on/off tip valve 118, the orifice 132 is not in fluid communication with the channel 128, but rather, faces the inner surface of the wall of the fluid tip end 114b, and liquid from the reservoir portion 114 cannot pass to the orifice 132, chamber 139 or outlet orifice 137.

Protruding stops 114c are formed on the exterior wall of the fluid tip end 114b in order to assist the user in moving between the first (open) and second (closed) tip positions. More particularly, the tab 118a is used to rotate the on/off tip valve 118 from one stop 114c to the other stop 114c to allow or prevent fluid flow through the on/off tip valve 118. Thus, as a consequence of the recessed channel 128 being arranged in only part of the tip end 114b, rotation of the on/off tip valve 118 in one direction (until stopped by one of the stops 114c) results in the fluid port 132 of the on/off tip valve 118 being held flush against the wall of the tip 114b, so as to not permit any liquid from the reservoir 114 to flow into the tip chamber 139. Correspondingly, when the on/off tip valve 118 is rotated in a second direction (to abut the second stop 114c, as shown in the figures), the fluid port 132 is aligned with, and in fluid communication with, the channel 128, and fluid can pass from the reservoir 114 into the chamber 139, via the channel 128 and port 132, when the device 110 is squeezed or inverted.

In one particular embodiment of the invention, the base portion floor 124 and upper fluid reservoir 114 are permanently fixed together to form a single (unitary) closed body. In one particular embodiment of the invention, the base adapter 112 and upper fluid reservoir 114 can be formed as a single piece, for example, through blow molding. Alternately, the base adapter 112 and fluid reservoir 114 can be made as separate pieces 112, 114 that are then permanently joined together, for example, using a mating lip and groove arrangement 130. If desired, the two pieces 112, 114 can be permanently joined together using any known method, such as, but not limited to, glue, heat or ultrasonic welding, screw or fiction fit, etc. Additionally, the hollow tube 131 is mated with the body of the on/off tip valve 118 (above the holes 136) by any means desired, including, but not limited to adhesive, heat or sonic welding and/or friction fit. Further, the tip/tube combination can be maintained in the body/base part using any of the above-described means, such as, but not limited to, adhesive, heat or sonic welding and/or friction fit, although a friction fit is preferred if more than one hollow tube is provided, as will be discussed more particularly below.

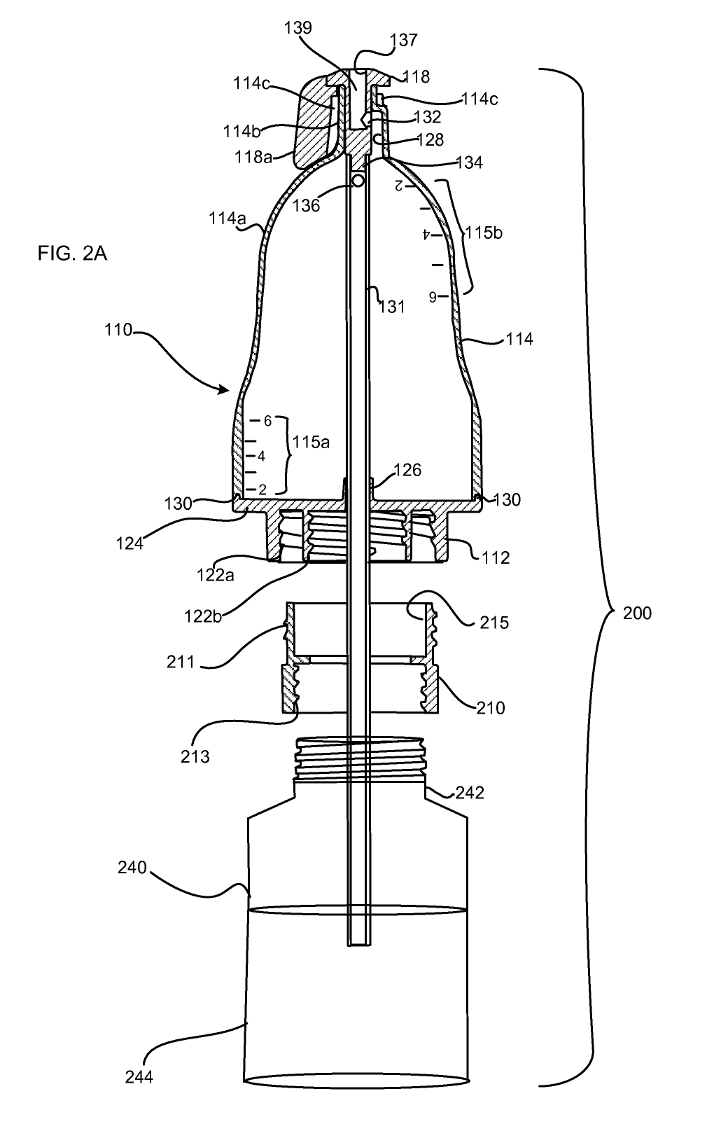

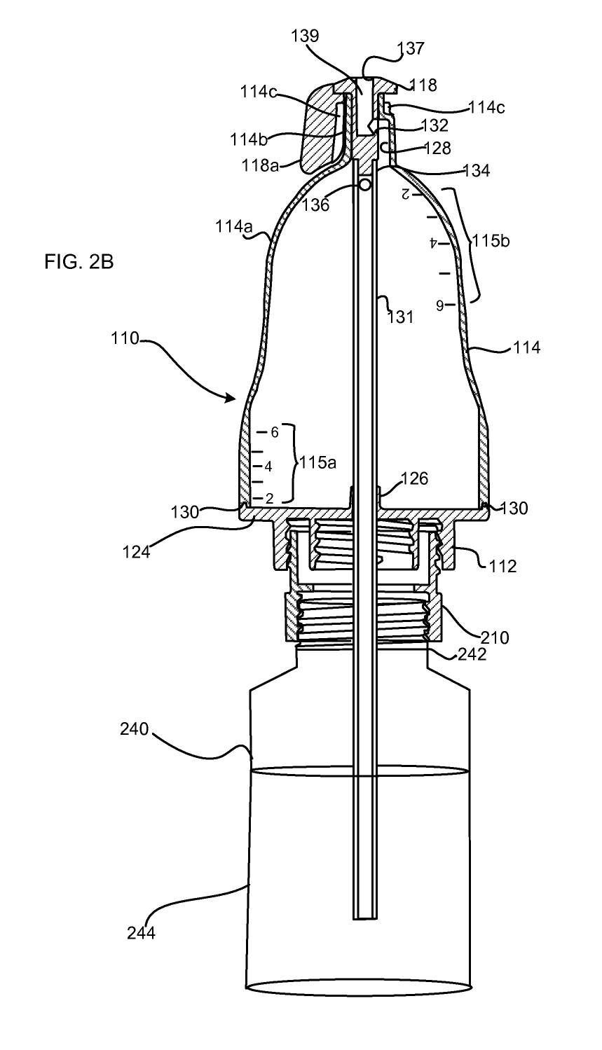

Referring now to FIGS. 2A and 2B, there is shown an alternate embodiment of a system 200 including a closed-system measuring and dispensing device 110, exactly as described in connection with FIGS. 1A and 1B, a commercially available liquid or fluid containing bottle 240 having a threaded neck 242. In the embodiment of FIGS. 2A-2B, the threaded neck 242 does not fit either connector 122a or 122b on the adapter portion 112 of the device 10. Consequently, a threaded adapter 210 can be provided to interface between the device 10 and the threaded neck 242 of the bottle 240. More particularly, the adapter 210 has an external thread 215 configured to matingly engage one of the connectors 122a or 122b, and an internal thread 213 which can matingly engage the threaded neck 242 of the bottle 240. In one particular embodiment of the invention, the external thread is threaded in a direction opposite to the internal thread, so that screwing the bottle neck into the internal thread does not unscrew the connection between the adapter 210 and the connector 122a or 122b. The adapter 210 additionally includes a central bore 215, through which the hollow tube passes into the fluid containing chamber 244 of the bottle 240. If the external thread 211 is sized to be mated with the outer connector portion 122a, the adapter 210 would additionally be configured to receive the inner connector portion 122b into the bore 215 of the adapter 210 without obstructing the connection of the adapter to the connector 122a or the passage of the hollow tube through the bore, as shown in FIGS. 2A and 2B.

Thus, by including a device 110 that accommodates a plurality of differently sized threaded bottle necks and an adapter 210 that accommodates a further differently sized threaded bottle neck, the device of the present invention can be used with a number of differently sized or types of commercially available bottles. For example, the device 110 utilizing the base adapter 112 and optional adapter 121 could be configured to provided threaded connections for quart, gallon, and industrial large mouth sized threaded bottles. This is not meant to be limiting, as the device 110 and/or the adapter 121 can be adapted to mate with other bottle sizes and types without departing from the scope of the invention.

Additionally, in one particular embodiment of the invention, the device 110 is provided to the consumer as part of a system or kit including the device 110 and one or more differently sized adapters 210. For example, although the device 110 may include two or more connector portions, such as 122a, 122b, the device can be adapted to fit a further plurality of differently sized bottle necks by providing a plurality of adapters with the device 110. Additionally, if desired, a system or kit including the device 110 can be provided to the consumer with a plurality of hollow tubes 131 of different lengths, such that a user can select the correct length tube for a particular commercially available bottle 240, snap or friction fit it to the on/off tip valve 118 and insert the particularly selected (customized) tip valve 118 and tube 131 combination into the device 110, from the top, until assembled as shown in the figures. In a further preferred embodiment, a kit is provided that includes a plurality of hollow tubes 131 of different lengths and one or more differently sized adapters 210, along with the device 110.

Referring now to FIGS. 1A-4, a method of using the device 110 will now be described. First, the device 110 is mated with the commercially available bottle 140, 240, either directly (FIG. 1B) or via an appropriate adapter 210 (FIG. 2B). If a plurality of hollow tubes are provided, this step additionally includes selecting a hollow tube of appropriate length from a plurality of such hollow tubes provided, mating it with an end 134 of the on/off tip valve 118 and mating the combination with the reservoir 114 and base 112 by threading the hollow tube through the fluid tip end 114b and hole 126 until the body of the on/off tip valve 118 is properly nested in the fluid tip end 114b. As described above, the on/off tip valve 118, will press fit into the fluid tip 114b of the closed fluid reservoir 114.

Once mated with the bottle 140, 240, the device 110 is used to pass fluid up the hollow tube 131, through the base portion floor 124 and into the fluid reservoir 114, via the holes 136 in the outer wall of the tube 131, just beneath the attachment point 314 to the on/off tip valve 118. The base portion floor 124 prevents fluid from draining back from the reservoir 114 into the commercial container 140, 240. The hollow tube 131 runs the length of the device 110, passing through the opening 126, through the base adapter 112 and into the commercially supplied fluid container 140, 240 attached to the base adapter 112 directly, or via the adapter 210. In one particular embodiment of the invention, the tube 131 will be sized to extend to the bottom of the chamber 144, 244 of the commercial bottle 140, 240.

In use, fluid can be passed from the bottle 140, 240 into the fluid reservoir 114 in a number of ways. When the device 110 is used on a squeezable commercial liquid container, fluid flow into the reservoir 114 can be achieved by exerting inward pressure on the walls of the commercial container (as illustrated in FIG. 3), thus pushing the fluid upward through the hollow tube 131 and into the fluid reservoir 114.

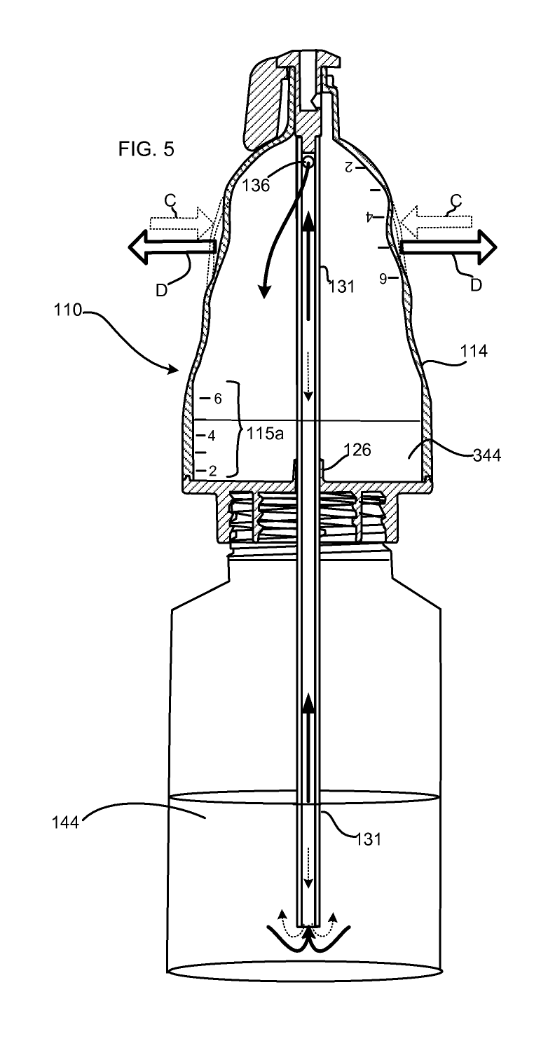

When using the device 110 on rigid commercial liquid containers 140, 240, fluid flow can be achieved by utilizing the device 110 as a pump mechanism to suck the fluid into the reservoir 114. For example, referring now to FIG. 5, squeezing the walls 114a of the reservoir 114 (i.e., in the direction of arrows “C”, as shown in dotted line) increases the pressure within the reservoir 114, by forcing air out of the reservoir via the tube 131 (shown in dotted lines) and/or the port 137. As a result of the increased pressure in the reservoir 114, suction that pulls the fluid upward through the hollow tube 131 and into the fluid reservoir 114 (illustrated by the arrows in solid line) is created once the sides of the reservoir 114 are released, as the sides expand to their natural position and shape (i.e., in the direction of arrows “D”). Repetitively squeezing and releasing the sides 114a can be used to pump more fluid into the reservoir 114, as desired.

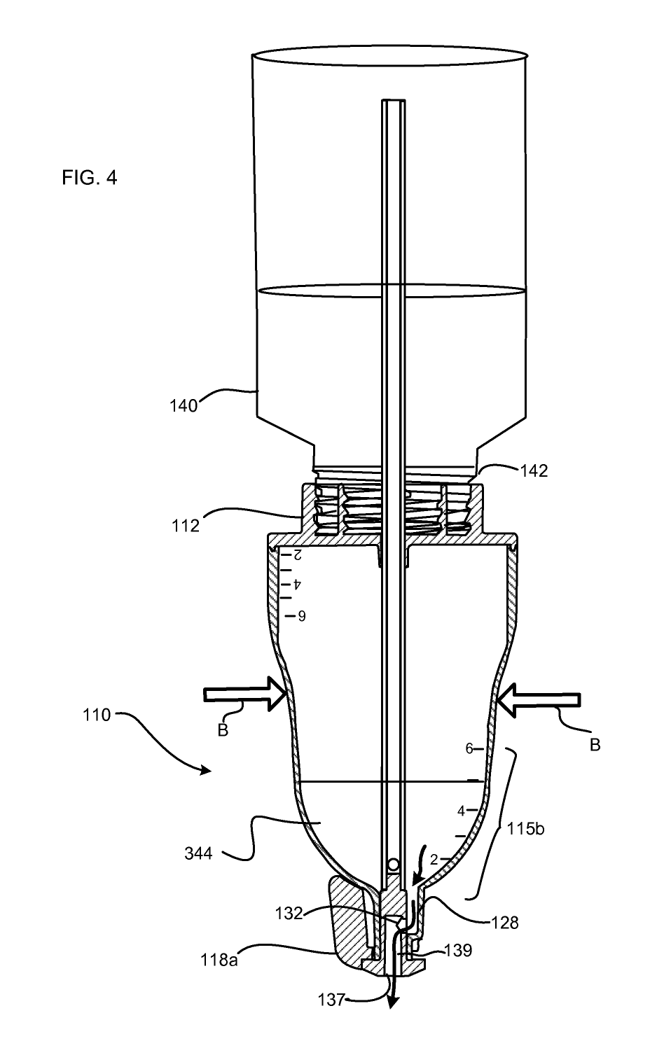

If desired, at least one set of marking indicia can be provided on the outer wall 114a of the upper fluid reservoir 114, in order to pre-measure the liquid to be poured. In one particular preferred embodiment of the invention, two sets of marking indicia 115a and 115b are provided, so that the level of liquid in the reservoir 114 can be read off while the reservoir is in both, a first, upright or filling position (FIG. 3), and a second, inverted or dispensing position (FIG. 4). As illustrated in the figures, marking indicia 115a is marked (i.e., printed or formed) on the walls of the reservoir 114 in an opposite fashion to marking indicia 115b, for ease in reading the fluid level when the device is both upright and inverted.

In use, liquid is pumped into the reservoir 114, either by squeezing the bottle 140, 240 or pumping the reservoir 110, until a desired amount of liquid has passed into the reservoir via the holes 136 of the hollow tube 131. If provided, the marking indicia 115a can be used to determine whether or not the an amount of fluid desired to be dispensed is held in the reservoir 114. By ensuring that only the desired amount of liquid enters the reservoir (according to the marking indicia), a user can be sure that only the desired amount of liquid (and no more) is dispensed from the bottle 140, 240.

Once the fluid reservoir 114 contains a desired amount of liquid to be dispensed, the on/off tip valve 118 is adjusted so that the orifice 132 is aligned with the channel 128, if it is not already in that configuration, and the device 110 is simply inverted to the dispensing position (FIG. 4) while inward pressure is exerted on the flexible walls of the fluid reservoir 114, thus causing the contents 344 of the reservoir to be dispensed from the port 137 of the dispensing tip 118. If a large amount of liquid to be dispensed is desired, the fluid reservoir 114 can be squeezed harder and/or multiple times, or the squeezable commercial container 140, 240 can be depressed inwardly (forcing air into the hollow tube, due to the bottle inversion), significantly adding to the dispensing rate of flow. The device 110 remains mated to the bottle 140, 240 during dispensing.

If desired, excess liquid in the reservoir 114 can be returned to the bottle 140, 240, by inverting the system 100, 200, and squeezing the reservoir 114, with the tip valve 118 in the closed position, thus creating a pressure to return fluid from the reservoir 114 (via the holes 136 in the tube 131) back to the connected container 140, 240. Additionally, after dispensing a desired amount of liquid from the reservoir 114, the device 110 can be removed from the bottle 140, 240, cleaned and reused on a different bottle 140, 240, or left on the original bottle 140, 240 until that bottle becomes empty, as desired.

The present invention provides a convenient, easy-to-use, reusable closed-system measuring and dispensing device, and an associated system and method for using such a device. Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

I claim:

1. A fluid dispensing device, comprising:
a flexible, closed fluid reservoir including a base portion and a dispensing portion;
said base portion including at least one threaded connector;
said dispensing portion including a dispensing tip;
a hollow tube extending from said dispensing tip, through said flexible, closed fluid reservoir and out said base portion, said hollow tube extending past a free end of said at least one threaded connector; and
said dispensing tip configured to rotate in said dispensing portion between a first, open position in which fluid from said reservoir can flow through said dispensing tip and a second, closed position in which fluid from said fluid reservoir cannot flow through said dispensing tip.

2. The fluid dispensing device of claim 1, wherein said at least one threaded connector includes a first threaded connector and a second threaded connector disposed concentric to said first threaded connector.

3. The fluid dispensing device of claim 2, wherein said first and second threaded connectors are disposed concentrically around a hole in said base portion through which said hollow tube passes.

4. The fluid dispensing device of claim 1, wherein said dispensing portion includes a neck portion including a fluid flow channel connecting said neck portion in fluid communication with said reservoir and said dispensing tip includes a first port, a second port and a chamber connecting said first port in fluid communication with said second port, said dispensing tip configured to rotate in said neck portion between said first, open position wherein said first port is in fluid communication with said fluid flow channel and said second, closed position, wherein said first port is not in fluid communication with said fluid flow channel.

5. The fluid dispensing device of claim 4, wherein said at least one threaded connector includes a first threaded connector and a second threaded connector disposed concentrically around a hole in said base portion through which said hollow tube passes.

6. The fluid dispensing device of claim 4, wherein said hollow tube is not in direct fluid communication with said dispensing tip, and said hollow tube includes at least one hole in a sidewall of the hollow tube in a portion of said hollow tube disposed inside said dispensing portion.

7. The fluid dispensing device of claim 1, wherein said dispensing portion is bell-shaped.

8. The fluid dispensing device of claim 1, further including at least one marking scale on said dispensing portion.

9. The fluid dispensing device of claim 8, wherein said at least one marking scale includes a first marking scale at a first end of said dispensing portion and disposed at a first orientation and a second marking scale at a second end of said dispensing portion having a second orientation inverted from said first orientation.

10. A fluid dispensing system, comprising:
a fluid dispensing device according to claim 1;
a threaded adapter including an external thread configured to matingly engage said at least one threaded connector and at least one further threaded connector of a size different from said at least one threaded connector.

11. The fluid dispensing system of claim 10, further including a plurality of threaded adapters for selective connection to said at least one threaded connector.

12. The fluid dispensing system of claim 10, further including a plurality of hollow tubes of different length, each selectively interchangeable with said hollow tube.

13. A method for dispensing fluid contained in a bottle having a threaded neck, comprising the steps of:
providing a fluid dispensing device, including:
a flexible, closed fluid reservoir including a base portion and a dispensing portion;
the base portion including at least one threaded connector;
the dispensing portion including a dispensing tip;
a hollow tube extending from the dispensing tip, through the flexible, closed fluid reservoir and out the base portion, the hollow tube extending past a free end of the at least one threaded connector; and
the dispensing tip configured to rotate in the dispensing portion between a first, open position in which fluid from the reservoir can flow through the dispensing tip and a second, closed position in which fluid from the fluid reservoir cannot flow through the dispensing tip;
inserting a free end of the hollow tube into the bottle;
engaging the at least one threaded connector with the threaded neck of the bottle while the free end of the hollow tube is disposed inside the bottle, to mate the fluid dispensing device with the bottle;
squeezing at least one of the bottle and the fluid dispensing device to transfer fluid from the bottle into the reservoir; and
dispensing fluid from the reservoir with the dispensing tip rotated to the first, open position.

14. The method of claim 13, wherein the dispensing portion of the fluid dispensing device includes a neck portion including a fluid flow channel connecting the neck portion in fluid communication with the reservoir and the dispensing tip includes a first port, a second port and a chamber connecting the first port in fluid communication with the second port, the dispensing tip configured to rotate in the neck portion between the first, open position wherein the first port is in fluid communication with the fluid flow channel and the second, closed position, wherein the first port is not in fluid communication with the fluid flow channel.

15. The fluid dispensing device of claim 13, wherein the at least one threaded connector includes a first threaded connector and a second threaded connector disposed concentrically around a hole in the base portion through which the hollow tube passes.

16. The method of claim 13, wherein the hollow tube includes at least one hole in a sidewall of the hollow tube and wherein the squeezing step includes squeezing the bottle to force fluid from the bottle up the hollow tube, out the at least one hole and into the reservoir.

17. The method of claim 13, wherein the hollow tube includes at least one hole in a sidewall of the hollow tube and wherein the squeezing step includes squeezing a sidewall of the fluid dispensing device to increase the pressure in the reservoir and releasing the sidewall of the fluid dispensing device to cause fluid from the bottle to be sucked up the hollow tube, out the at least one hole, and into the reservoir.

18. The method of claim 17, wherein the squeezing step is repeated a plurality of times until the fluid in the reservoir has reached a predetermined level.

19. The method of claim 13, wherein the fluid dispensing device includes at least a first marking scale at a first end of the dispensing portion and disposed at a first orientation and at least a second marking scale at a second end of the dispensing portion having a second orientation inverted from the first orientation and wherein the squeezing step is performed until a fluid level in the reservoir has reached a predetermined marking on the first marking scale and.

20. The method of claim 19, wherein the dispensing step include, inverting the fluid dispensing device and attached bottle to dispense fluid from the reservoir, via the dispensing tip, until a predetermined amount of fluid has been dispensed, according to the second marking scale.
